(19) United States
(12) Patent Application Publication
(10) Pub. No.: US 2015/0170275 A1
(43) Pub. Date: Jun. 18, 2015

(54) SYSTEM AND METHOD FOR PHYSICAL DELIVERY OF A FUTURES CONTRACT

(71) Applicant: QUIRKAFLEEG LIMITED, West Sussex (GB)

(72) Inventor: Julian D. A. WISEMAN, London (GB)

(73) Assignee: QUIRKAFLEEG LIMITED, West Sussex (GB)

(21) Appl. No.: 14/249,172

(22) Filed: Apr. 9, 2014

Related U.S. Application Data
(60) Provisional application No. 61/917,050, filed on Dec. 17, 2013.

(51) Int. Cl. G06Q 40/04

(52) U.S. Cl. CPC G06Q 40/04

(57) ABSTRACT

A method for physical delivery of a futures contract by an exchange operating as intermediary between shorts and longs in the futures contract, the method includes: publishing a list of deliverables; generating a modified list of deliverables in which some deliverables, having an algorithmically determinable weakness relative to other deliverables in the list of deliverables is/are removed, and the other deliverables remain; receiving information from shorts indicating which of the other deliverables included in the modified list are desired to be delivered; permitting longs to veto a small subset of the deliverables, for a cost ≧0, and for those longs so choosing to veto, accepting those vetoes; and assigning shorts to longs so as to maximize the number of shorts who can deliver the desired deliverables, while ensuring that, for each long that vetoes one or more deliverables, the vetoing long does not receive any of the vetoed deliverables.

### CROSS-REFERENCE TO RELATED APPLICATIONS

This application claims the benefit of U.S. Provisional Application No. 61/917,050, filed on Dec. 17, 2013, the contents of which are incorporated herein by reference in their entirety.

### BACKGROUND

In the field of futures contracts, the present disclosure provides a system and method that constrains the actions at delivery of longs and shorts, such that the cheapest-to-deliver will typically not be delivered, instead the contract resulting in an exchange of a deliverable nearer the median-to-deliver, or some other point on the range from cheapest to most expensive. This allows a futures contract to have an underlying of certificates of deposit from many banks.

Some futures contracts are ‘cash settled’: a final value is observed from some external source, and the longs are deemed to sell to the shorts at this price. This final value can be a formula, of any form, using any inputs. But cash settlement incentivizes participants to influence or manipulate that external price, a problem seen recently in the LIBOR scandal.

The alternative is physical delivery. If there were a single asset, of a single quality, traded sufficiently frequently in sufficient size, then delivery rules can be simple: deliver that one asset.

But typically delivered futures have multiple deliverables, some better and some worse than others. For example, multiple types of wheat may be delivered into the wheat future listed on the Chicago Mercantile Exchange. If delivering a better type, the rules say that delivery is at a premium of +3¢ per bushel. If delivering wheat with a higher concentration of deoxynivalenol, delivery is at a discount of −2¢ per bushel.

These rules are intended to make more equal the various deliverables, increasing the incentive to deliver a better-quality deliverable, reducing the incentive to deliver a worse-quality deliverable.

The same is true of bond futures. For example, if one had delivered into the CME's September2013 UST Bond future the 6¼% May 2030, the seller would have been paid 1.0260× the future's final price; if delivering the lower-coupon 4⅜ February 2038 the factor would have been the smaller 0.7937.

Market participants compute which of the multiple deliverables is the ‘cheapest-to-deliver’, after allowing for these adjustments and conversion factors, and deliver that.

Mostly, this works well. The prices of the various grades of wheat are quite well correlated. The various deliverable bonds are quite well correlated. If the price of one were to move by a large amount, the others would move in the same direction, by an amount that is predictable to within a tolerable error. The correlation never has a complete and catastrophic breakdown.

But this is not true of some other classes of assets. For example, in 1982 several exchanges in Chicago and New York listed a futures contract with an underlying of certificates of deposit issued by the big money-center banks of the era. Generally they were well correlated: if the yield of one bank's three-month CDs moved from 14% to 15%, so did the others, plus or minus a small amount.

That was until one of these money-center banks, Continental Illinois, started to go bankrupt. At which time its CDs were always the cheapest to deliver. There had been a complete breakdown of the correlation. The future ceased to be a useful hedge of generic inter-bank interest rates, and instead became an instrument settling against the perceived creditworthiness of a weak institution. Those CD futures stopped trading.

But, despite the problems with the cheapest-to-deliver, both the dearest-to-deliver and the median-to-deliver were still issued by good banks, and were reasonably correlated. It was the weakest bank's CDs that were behaving erratically, and so useless as a hedge for the others' CDs.

### SUMMARY

A method for providing physical delivery of a futures contract by an exchange operating as intermediary between shorts and longs in the futures contract, the method including: publishing a list of deliverables including at least one of possible deliverables and a class of deliverables; generating a modified list of deliverables in which some deliverables, having an algorithmically determinable weakness relative to other deliverables in the list of deliverables is/are removed, and the other deliverables remain in the modified list of deliverables; receiving information from shorts indicating which of the other deliverables included in the modified list of deliverables are desired to be delivered; permitting longs to veto a small subset of the deliverables, for a cost ≧0, and for those longs so choosing to veto, accepting those vetoes; and assigning shorts to longs so as to maximize the number of shorts who can deliver the desired deliverables, while ensuring that, for each long that vetoes one or more deliverables, the vetoing long does not receive any of the vetoed deliverables.

A method for providing physical delivery of a futures contract by an exchange operating as intermediary between shorts and longs in the futures contract, the method including: publishing a list of deliverables including at least one of possible deliverables and a class of deliverables; generating a modified list of deliverables in which some deliverables, having an algorithmically determinable weakness relative to other deliverables in the list of deliverables is/are removed, and the other deliverables remain in the modified list of deliverables; receiving information from shorts indicating which of the other deliverables included in the modified list of deliverables are desired to be delivered; permitting longs to veto a small subset of the deliverables, for a cost ≧0, and for those longs so choosing to veto, accepting those vetoes; and assigning, by a processor of a computer processing device of the exchange, shorts to longs so as to maximize the number of shorts who can deliver the desired deliverables, while ensuring that, for each long that vetoes one or more deliverables, the vetoing long does not receive any of the vetoed deliverables.

A non-transitory computer-readable storage medium storing instructions which when executed by a computer perform a method for providing physical delivery of a futures contract by an exchange operating as intermediary between shorts and longs in the futures contract, the method including: publishing a list of deliverables including at least one of possible deliverables and a class of deliverables; generating a modified list of deliverables in which some deliverables, having an algorithmically determinable weakness relative to other deliverables in the list of deliverables is/are removed, and the other deliverables remain in the modified list of deliverables; receiving information from shorts indicating which of the other deliverables included in the modified list of deliverables are desired to be delivered; permitting longs to veto a small subset of the deliverables, for a cost ≧0, and for those longs so choosing to veto, accepting those vetoes; and assigning shorts to longs so as to maximize the number of shorts who can deliver the desired deliverables, while ensuring that, for each long that vetoes one or more deliverables, the vetoing long does not receive any of the vetoed deliverables.

An exchange device for providing physical delivery of a futures contract, the exchange device operating as an intermediary between shorts and longs in the futures contract, the exchange device including: a computer processor; a memory; and the exchange device is configured to: publish a list of deliverables including at least one of possible deliverables and a class of deliverables, generate a modified list of deliverables in which some deliverables, having an algorithmically determinable weakness relative to other deliverables in the list of deliverables is/are removed, and the other deliverables remain in the modified list of deliverables, receive information from shorts indicating which of the other deliverables included in the modified list of deliverables are desired to be delivered, permit longs to veto a small subset of the deliverables, for a cost ≧0, and for those longs so choosing to veto, accepting those vetoes, and assign, by the computer processor, shorts to longs so as to maximize the number of shorts who can deliver the desired deliverables, while ensuring that, for each long that vetoes one or more deliverables, the vetoing long does not receive any of the vetoed deliverables.

These and other features and advantages of particular embodiments of the system and method for physical delivery of a futures contract will now be described by way of exemplary embodiments to which they are not limited.

### BRIEF DESCRIPTION OF THE DRAWINGS

The scope of the present disclosure is best understood from the following detailed description of exemplary embodiments when read in conjunction with the accompanying drawings. Included in the drawings are the following figures:

FIG. 1 illustrates a high level diagram of a system architecture that may be employed in accordance with an exemplary embodiment of providing physical delivery of a futures contract by an exchange;

FIG. 2 is a flow chart illustrating an exemplary method of an embodiment; and

FIG. 3 is a block diagram illustrating a computer system architecture in accordance with an exemplary embodiment.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

This description provides exemplary embodiments only, and is not intended to limit the scope, applicability or configuration of the system and method for physical delivery of a futures contract. Rather, the ensuing description of the embodiments will provide those skilled in the art with an enabling description for implementing embodiments of the system and method. Various changes may be made in the function and arrangement of elements without departing from the spirit and scope of the disclosure as set forth in the appended claims. Thus, various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner.

In view of the above, exemplary embodiments of the present disclosure provide a system and method in which an exchange facilitates the creation of contract having a set of rules that allows for there to be a large delivery basket comprising multiple assets, while being robust against a collapse in the price of a small sub-set of the deliverable basket. Applied to a future on an instrument resembling certificates of deposit, it can function like a physically delivered LIBOR future.

To compute LIBOR the British Bankers' Association asks some banks at what price that bank could borrow some particular currency at some particular maturity. The top and bottom quartiles of those are discarded, and the central two quartiles averaged. LIBOR does not measure the cheapest, nor the dearest: it measures, or attempts to measure, a middle-of-the-pack price.

The present disclosure therefore allows that ‘middle-of-the-pack price’ to be physically delivered, removing the incentive to manipulate that has disrupted the workings of LIBOR.

For a deliverable futures contract, the shorts will generally choose to deliver the cheapest to deliver (after allowing for conversion factors and other adjustments). For many contracts, this works well. But it would not work well for a deliverable inter-bank interest-rate contract, as the short would generally choose to deliver short-term paper from the weakest bank (e.g., Continental Illinois). So something more like a ‘median-to-deliver’ contract is needed.

Indeed, observe that the LIBOR formula has this median-to-deliver quality. Some banks are polled, the top and bottom quartiles discarded, and the central two quartiles averaged. However, being cash settled, some of the polled banks could sometimes benefit by misreporting numbers, and such behavior has been alleged.

So physical delivery is needed. There is a simple natural design for a median-to-deliver contract: there is a deliverable list; after trading stops each long can veto half of the deliverable list; and then the short delivers one of the remainder, presumably the cheapest of the more expensive half. But one of the purposes of a CD future is to allow banks to deliver their own CDs, and this very late vetoing precludes knowing in advance whether such self-delivery is possible. So it would not work as a funding future.

One might hope to allow longs to make the vetoing decisions earlier, but that doesn't work: those long a few months before delivery might be short at delivery. So vetoes must come after trading has ended.

Alternatively, the veto could be done by the exchange using ratings, again a few months before delivery. But not all potential investors fully trust ratings. So a workable requires contract requires some of each.

There is partial trust of rating agencies, but only partial. So it is assumed that banks' ratings are, mostly but not completely, a fair reflection of relative probabilities of default. That allows a rule specified in advance to remove the weakest banks from the list, early. Then, after trading stops, longs also have a ‘small’ veto: only a few names, and because that extra veto has a small cost, it is typically unused.

Exemplary embodiments of the present disclosure are described hereinafter in terms of the functions performed by an exchange, and the rules of the exchange constraining what may be done by shorts and longs. It is to be understood that the functions of the exchange as described hereinafter can be implemented, for example, in a computer system having one or more computer processing devices that are configured to individually and/or collectively perform the functions of the exchange. In a non-limiting embodiment, such computer processing devices may be personal computers or server computers which are each appropriately programmed to carry out the functions of the exchange as described herein. The computers each include a non-transitory computer-readable recording medium, which is a non-volatile memory such as a ROM, hard disk drive, flash memory, optical memory, etc. The non-transitory computer-readable recording medium has tangibly recorded thereon a computer program and/or computer-readable instructions which, when executed by a processor of the computer, cause the processor to perform the operative functions of the exchange as described herein.

In a non-limiting embodiment, the methods for providing physical delivery of a futures contract by an exchange operating as an intermediary between shorts and longs in the futures contract as described in this disclosure do not involve the use of a computer, processing device, etc.

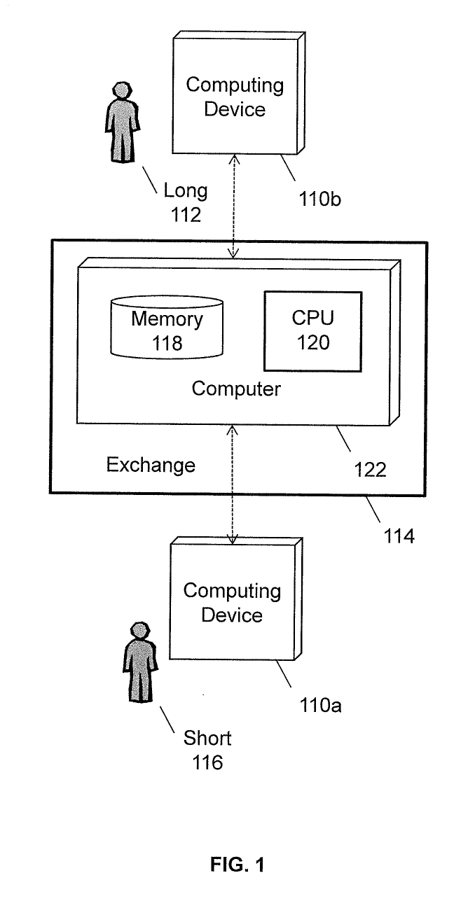

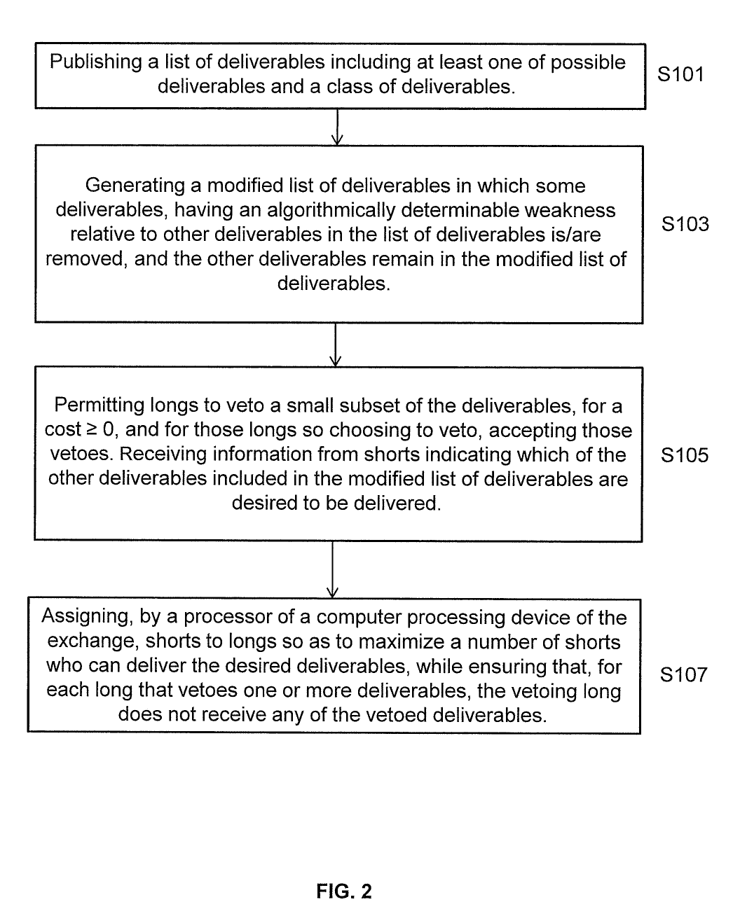

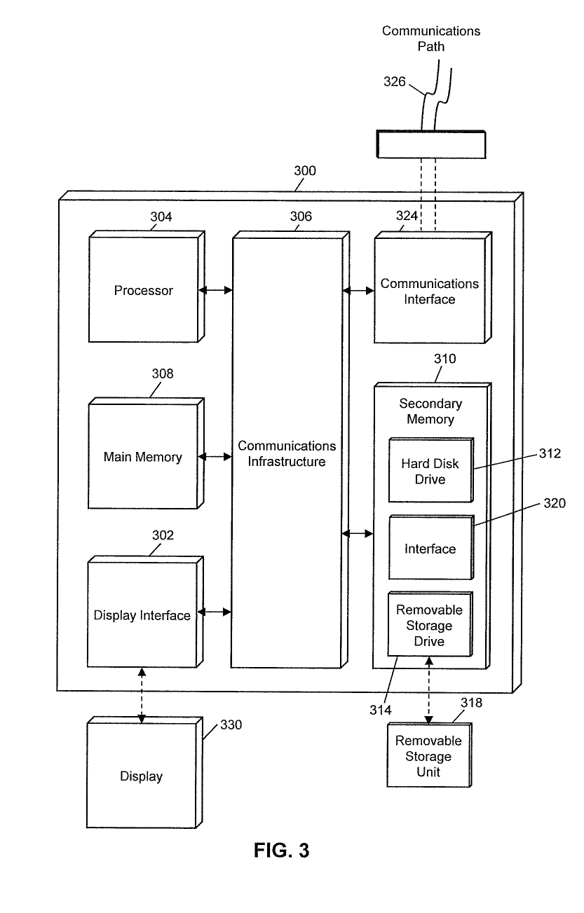

FIG. 3 illustrates a computer system 300 in which embodiments of the present disclosure, or portions thereof, can be implemented as computer-readable code. For example, the computing devices 110a, 110b and the exchange device (computer 122) of FIG. 1 can be implemented in the computer system 300 using hardware, software, firmware, non-transitory computer readable media having instructions stored thereon, or a combination thereof and may be implemented in one or more computer systems or other processing systems. Hardware, software, or any combination thereof may embody modules and components used to implement the methods and systems of FIGS. 1 and 2.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 318, and a hard disk installed in hard disk drive 312.

Various embodiments of the present disclosure are described in terms of this exemplary computer system 300. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Processor 304 may be a special purpose or a general purpose processor device. The processor device 304 may be connected to a communication infrastructure 306, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 300 may also include a main memory 308 (e.g., random access memory, read-only memory, etc.), and may also include a secondary memory 310. The secondary memory 310 may include the hard disk drive 312 and a removable storage drive 314, such as a floppy disk drive, a magnetic tape drive, an optical disk drive, a flash memory, etc.

The removable storage drive 314 may read from and/or write to the removable storage unit 318 in a well-known manner. The removable storage unit 318 may include a removable storage media that may be read by and written to by the removable storage drive 314. For example, if the removable storage drive 314 is a floppy disk drive or a universal serial port, the removable storage unit 318 may be a floppy disk or portable flash drive, respectively. In one embodiment, the removable storage unit 318 may be non-transitory computer readable recording media.

In some embodiments, the secondary memory 310 may include alternative means for allowing computer programs or other instructions to be loaded into the computer system 300, for example, the removable storage unit 318 and an interface 320. Examples of such means may include a program cartridge and cartridge interface (e.g., as found in video game systems), a removable memory chip (e.g., EEPROM, PROM, etc.) and associated socket, and other removable storage units 318 and interfaces 320 as will be apparent to persons having skill in the relevant art.

Data stored in the computer system 300 (e.g., in the main memory 308 and/or the secondary memory 310) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 300 may also include a communications interface 324. The communications interface 324 may be configured to allow software and data to be transferred between the computer system 300 and external devices, such as the computing devices 110a, 110b used by the short 116 and the long 112. Exemplary communications interfaces 324 may include a modem, a network interface (e.g., an Ethernet card), a communications port, a PCMCIA slot and card, etc. Software and data transferred via the communications interface 324 may be in the form of signals, which may be electronic, electromagnetic, optical, or other signals as will be apparent to persons having skill in the relevant art. The signals may travel via a communications path 326, which may be configured to carry the signals and may be implemented using wire, cable, fiber optics, a phone line, a cellular phone link, a radio frequency link, etc.

Computer program medium and computer usable medium may refer to memories, such as the main memory 308 and secondary memory 310, which may be memory semiconductors (e.g., DRAMs, etc.). These computer program products may be means for providing software to the computer system 300. Computer programs (e.g., computer control logic) may be stored in the main memory 308 and/or the secondary memory 310. Computer programs may also be received via the communications interface 324. Such computer programs, when executed, may enable computer system 300 to implement the present methods as discussed herein. In particular, the computer programs, when executed, may enable processor device 304 to implement the method illustrated by FIG. 1, or a similar method, as discussed herein. Accordingly, such computer programs may represent controllers of the computer system 300. Where the present disclosure is implemented using software, the software may be stored in a computer program product or computer readable medium and loaded into the computer system 300 using the removable storage drive 314, interface 320, and hard disk drive 312, or communications interface 324. Lastly, the computer system 300 may also include a display interface 302 that outputs display signals to a display unit 330, e.g., LCD screen, plasma screen, LED screen, DLP screen, CRT screen, etc.

### DEFINITIONS

Rating: average of the best two of the long-term senior ratings from Fitch, Standard & Poor's, Moody's. Compute the average using the numerical scores in the table on the right. If rated by only one of these agencies, one notch below that lone rating. If rated by none, score −99.

| | S&P | |
|---|---|---|
| Moody's | Fitch | Score |
| Aaa | AAA | 20 |
| Aa1 | AA+ | 19 |
| Aa2 | AA | 18 |
| Aa3 | AA− | 17 |
| A1 | A+ | 16 |
| A2 | A | 15 |
| A3 | A− | 14 |
| Baa1 | BBB+ | 13 |
| Baa2 | BBB | 12 |
| Baa3 | BBB− | 11 |
| Ba1 | BB+ | 10 |
| Ba2 | BB | 9 |
| Ba3 | BB− | 8 |
| ≦B1 | ≦B+ | −99 |

Central Bank: USD=Federal Reserve Bank of New York; GBP=Bank of England; EUR=European Central Bank. Emphasis: in [symbol] , only the ECB, not the national central banks.

Equivalent names: the exchange is to determine which names are to be deemed equivalent. Broadly, if two banks are, through relationship or by mutual guarantee, the same credit, the names should be deemed equivalent. So MegaBank (London) and MegaBank (New York) might well be deemed equivalent. In assessing equivalence the exchange is to pay regard both to the facts and to the belief of market participants.

In default: broadly, a bank or a debt instrument is ‘in default’ if a credit event has occurred. The occurrence of a credit event is to be determined by an ISDA Credit Derivatives Determinations Committee, or by the central bank, or by other means that the exchange believes to be generally acceptable. However, the exchange is also to use sensible judgment. For example, if a bank defaulted, a part of the bank was rescued and is now issuing again, it might be that newly issued debt instruments are not in default, even if some older paper is in default.

Intermediary: This disclosure recites “an exchange operating as intermediary between shorts and longs in the futures contract” and variations thereon. In this context, an exchange acts as an “intermediary” in the sense that it lists contracts to trade, defines the rules and regulations of those contacts, which include the obligations and rights of those long and of those short such contracts. Further the exchange makes possible the trading of such contracts by market participants, and facilitates delivery. Typically some of these functions, most especially those concerning the handling of money and securities, will be executed by a clearing house chosen by the exchange, the term ‘exchange’ covering both.

(a) Deliverable Basics

The delivery date is the third Wednesday of the delivery month.

The deliverable instruments are non-subordinated Certificates of Deposit; non-subordinated Commercial Paper (the abbreviation ‘CDs’ henceforth covering both); or an instrument on the ‘Side List’ (broadly, Treasury bills or Central-Bank bills).

Each deliverable must be a fixed-income instrument, paying a full 100 principal in the appropriate currency for that contract, and a either no coupon (so a discount instrument), or in the same currency a fixed positive coupon that is within ±50 bp of the exchange delivery settlement price (EDSP) yield, exactly on the boundary being permitted (1 bp being 0.01 percentage points of yield).

A deliverable CD's date of first issue cannot be before 37 days before the contract's delivery date. (As 37 days includes the Monday before the previous IMM date.)

CDs must be issued under the law of, and subject to the courts of, the following jurisdictions:

USD: New York;

GBP: England and Wales;

EUR: England and Wales.

(i) Minimum and Maximum Maturities

All deliverables are subject to the same minimum and maximum maturity dates.

Start by computing two dates.

For a three-month contract, these are: three months from delivery plus one day; and the third Wednesday in two months, plus 31 days.

For a six-month contract, these are: six months from delivery plus one day; and third Wednesday in three months, plus three months, plus one day.

Then the maximum maturity date is the later of these dates (if not a business day, the next). The minimum maturity date is the earlier of the two computed dates, minus two business days. In a non-limiting embodiment, these constraints can be stored in the memory 118 of the computer 122.

Alternatively, the maturity date could be the appropriate number of months (1 or 3 or 6 or 12, according to the notional tenor of the futures contract) after the delivery date, calculated using the market-standard rule and calendar for that currency.

(a) Occasional Review: The Side List

There is to be a “Side List” of issuers and security types. This is to be reviewed by the exchange from time to time, but is likely to change only very rarely. Until changed, in EUR and USD this comprises bills and CDs and equivalent instruments issued by the central bank. In GBP, it comprises that, plus Treasury bills.

(b) Eligible Issuers

The deliverable Certificates of Deposit and Commercial Paper are issued by banks or other deposit-taking institutions. The process by which it is chosen which banks' CDs can be delivered is rather intricate, as follows.

A list of candidate deliverable issuers is created (and the already-mentioned side-list of definite deliverables), the candidate list being pruned over time. In a non-limiting embodiment, the list of candidate deliverable issuers can be created by the exchange 114 by receiving data by a receiving unit, such as the communications interface 324, from an external source such as the internet or a database.

(i) Delivery Minus 20 Weeks: The Basic List

The ‘Basic List’ comprises banks:
With investment-grade rating (a numerical rating ≧11); and
Deemed by brokers and investors to be both active issuers of relevant-currency CDs, and widely accepted.

If a banking group issues CDs from several entities, each separate entity on the Basic List must satisfy both of the above conditions.

That done, if there are fewer than eight non-equivalent names on the list, the exchange is to add the most active of those with numerical ratings≧10 but <11 to make the total up to eight, if that is possible. This might require a delay in the publication of the Basic List.

That done, if there are fewer than six non-equivalent names on the list, the exchange, after consulting with the relevant central bank and market participants, and having regard both to ratings and the extent of issuance, is to add such names as it thinks fit. This might require a delay in the publication of the Basic List.

(ii) Delivery—42 Calendar Days: Observe a Median

Forty-two calendar days before delivery (or on the following business day) a median rating is computed. This is a median of the ratings of the banks in the Basic List, except that, for this purpose, some banks are ignored.
1. Ignore banks in default.
2. Deem equivalent names to be merged and to have a rating equalling the worst of the ratings of the equivalent names.
3. Also ignore those that have ceased to have an investment-grade rating (except that if this leaves fewer than six non-equivalent names, choose the best rating such that at least six non-equivalent names have that rating or better, and ignore those worse than that rating).

Compute the median of that subset of the Basic List. If the number of banks in this sub-set is even, the median is to be the arithmetic average of the ratings of the two middle banks.

(iii) Delivery—6 Calendar Days (a Thursday): The Delivery List

On the Thursday that is 6 days before the delivery day (or if not a business day, the day before) the exchange is to publish the ‘Delivery List’, which is a subset of the Basic List. The Delivery List is the Basic List, from which some banks might have been removed. This starts by repeating the median calculation done delivery—42 calendar days. Then define the ‘threshold rating’ to be one notch weaker than the weaker of the two medians. So if the two medians were A/A2=15 and A+/A1=16, the threshold would be A−/A3=14. Then the Delivery List is the Basic List, from which some banks might have been removed.
1. Those for which a credit event has occurred are removed. For example, those in default are removed.
2. Those that have ceased to have an investment-grade rating are removed; except that if this were to take the number of non-equivalent banks from at least eight to below eight, the threshold is to be lowered to the best rating that still keeps the number of non-equivalent banks at least eight. In a non-limiting embodiment, if after the removal there are fewer than six non-equivalent names left, choose the best rating such that at least six non-equivalent names have that rating or better, and ignore those worse than that rating.
3. After these steps, and again merging equivalent names, the median rating of the remaining banks is to be computed. If an even number of banks, the median is to be the arithmetic average of the central two banks.
4. Two medians have been computed. From the lesser of those two medians, subtract one (so, in effect, a median of A/A2=15 gives a cut-off of A−/A3=14). Banks with ratings equal to or exceeding this cut-off are kept; those with worse are removed. For example, banks with ratings worse than the threshold rating are removed; and those equal or better than the threshold are retained.

(iv) 09:30-11:30, Delivery—5 Calendar Days (a Friday)

The EDSP is observed at 09:30 am five calendar days before delivery, and trading then ceases. All times are: for USD, New-York time; for EUR and GBP, London time.

Next are exchanges of information.

Set n to be the number of non-equivalent names on the Delivery List.

Each long may optionally veto some of the names on the Delivery List, but not more than n÷10 names (rounding to nearest, exact halves up). For each name a long vetoes, that long's contract's EDSP is increased by 12½ bp (the delivery yield is lessened by 12½ bp). Equivalent names are free, so vetoing both MegaBank (New York) and MegaBank (London) costs only 12½ bp, and counts as just one towards the maximum of n÷10 vetoes. A long will never receive a name vetoed by that long. Vetoes must be submitted by 11:30 am on the day that the EDSP was observed.

Also by 11:30 am on the day that the EDSP was observed, shorts may optionally submit a list of ‘hoped deliveries’. This list costs nothing to submit, and may be of any length. This is only a hope, which might or might not be accommodated.

The full data of vetoes and hopes are then published, ideally by noon. So each set of vetoes is published, and the number of lots with that set: i₀×{ }; i₁×{BankA}; i₂×{BankB}; i₃×{BankA, BankB}; etc. Likewise for the hoped deliveries.

Those data having been received, longs are then assigned to shorts. This is done in the manner that maximises the number of shorts able to deliver a name on that short's ‘hoped deliveries’ list. As soon as possible shorts are given veto lists, and, computable from the EDSP and the length of each list (merging equivalents), delivery yields.

(v) Before 10 am, Delivery—2 Calendar Days

There is one further veto, in the hands of the exchange. By 10 am two days before delivery, so on the Monday, the exchange is to veto names on the Delivery List that are in default, provided that there are fewer than n÷2 such names (halves up).

This protects longs against a weekend bankruptcy, but does not protect against downgrades, even to junk. So if just Lehman went bust over the weekend, its debt would not be deliverable; but if the whole banking system imploded, there would be no further veto.

(vi) ≦12:00, Delivery—2 Calendar Days (a Monday)

By noon on the Monday two days before delivery, shorts state what will be delivered. Obviously, for each contract, this cannot have been issued by a vetoed name. Either it was issued by a non-vetoed name on the Delivery List; or it is an eligible security from the Side List.

The delivery notice is to specify the issuer, maturity date, and coupon, and perhaps other identifiers.

(vii) Delivery (a Wednesday), or if not a Business Day, Day after

On the delivery day, shorts deliver the correct nominal amount ($1,000,000 or [symbol] 1,000,000 or [symbol] 1,000,000 or [symbol] 100,000,000, as appropriate). Longs pay cash.

Define:

DeliveryYield=100−EDSP, minus 0.125=12½ bp for each name vetoed by the long, vetoes of equivalent names being deemed one veto.

MoneyMarketBasis=365 for £; 360 for $ and [symbol] .

ActualDays=the security's remaining maturity in calendar days. If the maturity is not a business day, the following business day is used.

RedemptionAmount=the cashflow to be paid at maturity amount on 1,000,000 (or whatever is the future's notional size) of the security. For a zero-coupon security this is the future's notional size; for a security with a positive coupon, more.

NominalDays=the number of calendar days to the maximum maturity date.

Then the invoice amount is:

$$RedemptionAmount \times {( 1 + \frac{DeliveryYield}{100} \frac{NominalDays}{MoneyMarketBasis} )}^{- ( \frac{ActualDays}{NominalDays} )}$$

### Regulator's Information Requirement, Possibly

Is it worth vetoing BankA? If BankA is about 8% of the open interest, and nobody else will veto, then it is not worth vetoing unless BankA is at least 25 bp÷0.08=312½ bp over the next-weakest bank. This entails a dependency on BankA's position, about which a regulator might be concerned. There is an easy remedy, and it is an obligation to reveal short positions.

Each day from twelve days before delivery, banks whose CDs are deliverable must reveal to the exchange whether they or their agents are short, and if so how many lots and a brief statement as to what is planned for this position (close, shrink, maintain, enlarge). The exchange then publishes this information. This will keep regulators happy.

(c) Clearing: Special Arrangements

The clearing house might insist on a special ‘mutual support arrangement’ for this contract. But such support would be of a remarkably upside-down nature.

Assume that BankA and BankB have some form of mutual support arrangement. BankA hits trouble. BankB then has to start writing helpful checks, and money flows out of BankB. Maybe BankB will have trouble too? Not with this arrangement. If one of the members of this mutual support arrangement needs help, money will flow in to the helpers, not out from them.

Assume that, as trading ceases, BankA, a CD-issuing clearing member, is short, and widely vetoed. BankA can no longer deliver its own CDs, or can no longer deliver enough of them. If it has the cash to buy others' CDs, or eligible Side-List instruments, then those could be delivered, fixing the problem. But if not, what happens?

What happens is that the ‘mutual support arrangement’ allows clearing house transfers the shorts, at the EDSP, to the other mutually-supporting members who have not been much vetoed. They would deliver their own CDs, and receive payment for them.

Their risk committees will love this: as a major bank hits trouble, they receive term money.

Of course this would not fix BankA's funding problem. But it would fix the possible failure to deliver into this contract.

The precise form of this arrangement is not specified here. But because it is everybody's interests, even when ‘support’ is invoked, a mutually satisfactory arrangement is easily reachable.

Indeed, because that self-interest is so strong and time-consistent, the clearing house might even be willing to trust that it could be arranged at the last moment. (“One of your competitors is going bust. Would you like some money?”)

(d) Variations

£: UK liquidity rules focus on the next three months. Therefore three-month funding is not very helpful, as it very quickly becomes too short. Six-month funding suffices, so the (first) GBP contract should be six-month.

$: The US rules focus on the next 30 days, so the USD contract should be three-month, which also matches the outstanding swaps.

[symbol] : Euro has more variety: when the ECB's regulation starts to dominate, this might change. Perhaps three-month first.

Obviously, other tenors could follow. As could other currencies: JPY CHF AUD CAD, and even the likes of SEK NOK DKK NZD, SGD KRW MXN HKD TWD PLN CZK ZAR ILS TRY.

There could also be a sub-investment-grade contract, which might be most important in [symbol] , then $, and probably not worthwhile in £. Sub-IG would require a slightly different construction of the Basic and Delivery Lists.

Exchange For Physical should be permitted, and even encouraged. Most investors will be full of at least some names. Other names will want the certainty of not being vetoed. So, in the few weeks before trading ceases, EFP would help both sides.

Of course there should be options. Expiring when? Margining constraints necessitate that the option expiry is substantially before that of the futures. As delivery approaches, the clearing house is likely to increase initial margins for those shorts unlikely to self-deliver. This increase protects the clearing house against a failure to deliver, and also incentivizes speculators to roll positions forward. So consider the position of a speculator who owns a far out-of-the-money put, currently marked-to-market at zero. For the clearing house to require posting of precautionary initial margin of, say, 50¢ (in case it should become a short in the future), seems nonsensical for an option worth about nothing. Indeed, it might force holders to sell, even if the best bid was negative! Yuck. So expiry has to be substantially before the end of trading. The Friday after the third Wednesday of the previous month has the advantages of: being consistently after that month's ECB and BoE meeting dates; being before the current month's; and in December being before Christmas eve.

Most outstanding swaps settle against LIBOR or Euribor or TIBOR. But for legal reasons banks want to be out of the fixing business, so might be willing to adjust outstanding IBOR swaps to a physically-delivered alternative, once it has built momentum. A multilateral agreement might specify that, a year before each fixing, it is switched into futures. There might be a future for each day. Or maybe one contract per week or per month, fixings either being moved to the nearest; or the one settling in the same calendar week or month; or interpolated into the contracts either side.

(d) Pruning the List of Deliverables

Accordingly, by allowing longs to veto a sub-set of the deliverables of a futures contract, the contract can become median-to-deliver (or any other percentile-to-deliver) rather than just cheapest-to-deliver. This veto could be exercised, in whole or in part, by the exchange itself, if there is data allowing that to be done algorithmically (such as an opinion of a rating agency). In a non-limiting embodiment, the communication interface 324 of the exchange 122 receives data including ratings that allow the exchange 324 to shorten the list of deliverables.

Before delivery, the exchange would publish a full list of possible deliverables or class of deliverables, perhaps detailing any applicable conversion factors or adjustments. It might be that the exchange would pre-prune this list of deliverables, perhaps defined by credit rating, perhaps by recent credit event, or by some other algorithm. In a non-limiting embodiment, the communication interface 324 of the exchange 122 receives data, including the credit ratings, from a database of a credit agency or other source that allows the exchange 324 to shorten the list of deliverables.

Let n be the number of deliverables on this list, or the number of appropriately defined groups of deliverables. Then, soon after the cessation of trading, longs could optionally submit a list of vetoed deliverables. There would be a maximum length of this list: perhaps 4, perhaps n÷10, or perhaps √n (with a specified rounding rule, and a special case for small n). There might be some penalty, that being an increase in deliverable invoice, paid by the long, either for submitting any list, or per veto. But a long would never receive a vetoed deliverable.

Shorts could optionally submit a list, of any length, of intended hoped-for deliveries. This can be thought of as saying “It would be convenient to me to deliver one of the following. Please assign me a long who has not vetoed them all.”

An algorithm or program, perhaps executed by a processor of a computer processing device of the exchange, would then assign longs to shorts, in a manner that minimizes the number of shorts who cannot deliver anything on their list of hoped-for deliveries.

A tie might be resolved by the algorithm by further maximizing some mix of variables including:
Shorts' choice about what to deliver; and
The variety of deliverables received by each long (so, in a CD future, minimizing the concentration of credit risk received by the longs).

Such a design of a futures contract has multiple possible variations. As would be obvious to one skilled in the art, there can be: different currencies; or different maturities (most obviously ≈1-month, ≈3-month and ≈6-month). The contract could allow delivery of CDs issued by sub-investment-grade banks, the floor of the rating perhaps being Ba3/BB−, numerically 8. For such a contract the number of vetoes each long could use would depend on the number of weaker deliverable banks (perhaps those ≧8 but <11), rather than the number of banks of any rating on the whole Basic List. Further the cost of each veto might be larger: perhaps 100 bp rather than 12½ bp.

Such a contract also has uses relating to the large body of existing swaps. Most outstanding swaps settle against LIBOR or Euribor. But for legal reasons, banks want to be out of the IBOR business, so they might be willing to adjust IBOR swaps to a physically-delivered alternative. A multilateral agreement might specify that, some while (perhaps a few months or a year) before a coupon is due to be paid, it is switched either into one future, or interpolated into the two futures contracts with immediately prior and subsequent settlement dates.

In a non-limiting embodiment shown in FIG. 1, an exchange 114 operates as an intermediary between at least one short 116 which can have a computing device 110a such as a computer, smartphone, tablet, etc., and at least one long 112 which can have a computing device 110b such as a computer, smartphone, tablet, etc. The exchange 114 can include a computer/server 122 that is an exchange device that includes at least a computer memory 118 and a computer processor 120. The exchange 114 can also include a means for providing physical delivery of the futures contract. The means for providing the physical delivery contract can be a computer, such as the computer 122 in FIG. 3, which performs the physical delivery of the contract by transmitting the contract via email. The contract can be transmitted by other electronic methods, such as WiFi, Bluetooth, NFC, etc. The computer 122 can also provide physical delivery by formatting the contract into a printable form, transmitting the printable form of the contract to a printer, which allows the contract to be printed on a substrate by a printing device.

FIG. 2 illustrates an exemplary method for providing physical delivery of a futures contract by an exchange operating as intermediary between shorts and longs in the futures contract. Step S101 includes publishing a list of deliverables including at least one of possible deliverables and a class of deliverables. In an exemplary embodiment, the list is published by the computer processing device 122 of the exchange 114. Also, in a non-limiting embodiment, list of deliverables can be generated by the exchange 114, based on data received by the communications interface 324 from external databases or sources (e.g., the world wide web). Step S103 includes generating a modified list of deliverables in which some deliverables, having an algorithmically determinable weakness relative to other deliverables in the list of deliverables is/are removed, and the other deliverables remain in the modified list of deliverables. In a non-limiting embodiment each deliverable can be assigned a numerical score that indicates the relative weakness of the deliverable, and a table including data of the deliverables and associated numerical weakness scores can be stored in the memory 118 of the computer processing device 122 of the exchange 114.

In an exemplary embodiment, the modified list of deliverables is generated by the computer processing device 122 of the exchange 114. Step S105 includes permitting longs 112 to veto a small subset of the deliverables, for a cost ≧0, and for those longs so choosing to veto, accepting those vetoes. In an exemplary embodiment, a long 112 provides a veto to the computer processing device 122 of the exchange 114 by using the computing device 110b. In a non-limiting embodiment, data including the veto is contained in a data packet that is sent from a transmission device of the computing device 110b and is received in the communication interface 324 of the computer processing device 122.

The exchange 114 can also store the cost of the veto/vetoes in the memory 118, and use this information in calculating the total cost of the contract. In an non-limiting embodiment, the total cost of the contract can be calculated by adding the total cost of the deliverables to the total cost of the vetoes. Step S105 also includes receiving information from shorts 116 indicating which of the other deliverables included in the modified list of deliverables are desired to be delivered. In an exemplary embodiment, the information from a short data sent by a computing device 110a to the computer processing device 122 in the exchange 114 as shown in FIG. 1. The data that is sent can include a data packet including a table which associates each deliverable with a corresponding data value indicating how much the particular deliverable is desired to be delivered by the short. For example, the data value could be a numerical score (e.g., a value from 1-10, 1-100, etc.), a letter grading (e.g., A-Z), etc. The processes in step S105 can happen simultaneously, the longs can veto prior to receiving the information from the shorts, or the information from the shorts is received prior to the longs vetoing.

Step S107 includes assigning, by the computer processor 120 of the computer processing device 122 of the exchange, shorts 116 to longs 112 so as to maximize the number of shorts 116 who can deliver the desired deliverables, while ensuring that, for each long 112 that vetoes one or more deliverables, the vetoing long does not receive any of the vetoed deliverables. The algorithm that performs the assigning can be stored in the memory 118 of the computer processing device 122 or stored external to the exchange 114.

While various exemplary embodiments of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

As can be seen above, the application providing method and system can be implemented in any number of ways as discussed above, or as will become apparent to those skilled in the art after reading this disclosure. These embodiments, as well as variations and modifications thereof, which will occur to those skilled in the art, are encompassed by the application providing method and system. Hence, the scope of the application providing method and system is limited only by the metes and bounds as articulated in the claims appended hereto.

What is claimed is:

1. A method for providing physical delivery of a futures contract by an exchange operating as intermediary between shorts and longs in the futures contract, the method comprising:
publishing a preliminary list of deliverables including at least one of possible deliverables and a class of deliverables;
generating a modified list of deliverables in which some deliverables, having an algorithmically determinable weakness relative to other deliverables in the list of deliverables is/are removed, and the other deliverables remain in the modified list of deliverables;
permitting longs to veto a small subset of the deliverables, for a cost ≧0, and for those longs so choosing to veto, accepting those vetoes; and
receiving information from shorts indicating which of the other deliverables included in the modified list of deliverables are desired to be delivered;
assigning shorts to longs so as to maximize the number of shorts who can deliver the desired deliverables, while ensuring that, for each long that vetoes one or more deliverables, the vetoing long does not receive any of the vetoed deliverables.

2. The method of claim 1, wherein the deliverables are at least one of certificates of deposits, commercial paper, treasury bills, and central-bank bills.

3. The method of claim 1, wherein the veto of the preliminary set of the deliverables is performed by the exchange using ratings.

4. The method of claim 3, wherein the used ratings are ratings of two or more rating agencies that are averaged.

5. The method of claim 1, wherein for n deliverables on the list, the long may not veto more than n/10 deliverables, rounding to nearest value, and exact half values round up.

6. The method of claim 1, wherein the cost of the long's veto is included in the long's contract price.

7. The method of claim 1, wherein the modified list of deliverables is generated by the exchange based on credit rating or a recent credit event of the possible deliverables or their issuers.

8. A method for providing physical delivery of a futures contract by an exchange operating as intermediary between shorts and longs in the futures contract, the method comprising:
publishing a preliminary list of deliverables including at least one of possible deliverables and a class of deliverables;
generating a modified list of deliverables in which some deliverables, having an algorithmically determinable weakness relative to other deliverables in the list of deliverables is/are removed, and the other deliverables remain in the modified list of deliverables;
permitting longs to veto a small subset of the deliverables, for a cost ≧0, and for those longs so choosing to veto, accepting those vetoes; and
receiving information from shorts indicating which of the other deliverables included in the modified list of deliverables are desired to be delivered;
assigning, by a processor of a computer processing device of the exchange, shorts to longs so as to maximize the number of shorts who can deliver the desired deliverables, while ensuring that, for each long that vetoes one or more deliverables, the vetoing long does not receive any of the vetoed deliverables.

9. The method of claim 8, wherein the deliverables are at least one of certificates of deposits, commercial paper, treasury bills, and central-bank bills.

10. The method of claim 8, wherein the veto of the preliminary set of the deliverables is performed by the exchange using ratings.

11. The method of claim 10, wherein the used ratings are ratings of two or more rating agencies that are averaged.

12. The method of claim 8, wherein for n deliverables on the list, the long may not veto more than n/10 deliverables, rounding to nearest value, and exact half values round up.

13. The method of claim 8, wherein the cost of the long's veto is included in the long's contract price.

14. The method of claim 8, wherein the modified list of deliverables is generated by the exchange based on credit rating or a recent credit event of the possible deliverables or their issuers.

15. A non-transitory computer-readable storage medium storing instructions which when executed by a computer perform a method for providing physical delivery of a futures contract by an exchange operating as intermediary between shorts and longs in the futures contract, the method comprising:
publishing a list of deliverables including at least one of possible deliverables and a class of deliverables;
generating a modified list of deliverables in which some deliverables, having an algorithmically determinable weakness relative to other deliverables in the list of deliverables is/are removed, and the other deliverables remain in the modified list of deliverables;
permitting longs to veto a small subset of the deliverables, for a cost ≧0, and for those longs so choosing to veto, accepting those vetoes; and
receiving information from shorts indicating which of the other deliverables included in the modified list of deliverables are desired to be delivered;
assigning shorts to longs so as to maximize the number of shorts who can deliver the desired deliverables, while ensuring that, for each long that vetoes one or more deliverables, the vetoing long does not receive any of the vetoed deliverables.

16. The non-transitory computer-readable storage medium of claim 15, wherein the deliverables are at least one of certificates of deposits, commercial paper, treasury bills, and central-bank bills.

17. The non-transitory computer-readable storage medium of claim 15, wherein the veto of the preliminary set of the deliverables is performed by the exchange using ratings.

18. The non-transitory computer-readable storage medium of claim 17, wherein the used ratings are ratings of two or more rating agencies that are averaged.

19. The non-transitory computer-readable storage medium of claim 15, wherein for n deliverables on the list, the long may not veto more than n/10 deliverables, rounding to nearest value, and exact half values round up.

20. The non-transitory computer-readable storage medium of claim 15, wherein the cost of the long's veto is included in the long's contract price.

21. The non-transitory computer-readable storage medium of claim 15, wherein the modified list of deliverables is generated by the exchange based on credit rating or a recent credit event of the possible deliverables or their issuers.

22. An exchange device for providing physical delivery of a futures contract, the exchange device operating as an intermediary between shorts and longs in the futures contract, the exchange device comprising:
a computer processor;
a memory; and
the exchange device is configured to:
publish a list of deliverables including at least one of possible deliverables and a class of deliverables,
generate a modified list of deliverables in which some deliverables, having an algorithmically determinable weakness relative to other deliverables in the list of deliverables is/are removed, and the other deliverables remain in the modified list of deliverables,
permit longs to veto a small subset of the deliverables, for a cost ≧0, and for those longs so choosing to veto, accepting those vetoes, and
receive information from shorts indicating which of the other deliverables included in the modified list of deliverables are desired to be delivered,
assign, by the computer processor, shorts to longs so as to maximize the number of shorts who can deliver the desired deliverables, while ensuring that, for each long that vetoes one or more deliverables, the vetoing long does not receive any of the vetoed deliverables.

23. The exchange device of claim 22, further comprising:
means for providing the physical delivery of the futures contract.

24. The exchange device of claim 22, wherein the veto of the preliminary set of the deliverables is performed by the exchange device using ratings.

25. The exchange device of claim 24, wherein the used ratings are ratings of two or more rating agencies that are averaged.

26. The exchange device of claim 22, wherein for n deliverables on the list, the long may not veto more than n/10 deliverables, rounding to nearest value, and exact half values round up.

27. The exchange device of claim 22, wherein the cost of the long's veto is included in the long's contract price.

28. The exchange device of claim 22, wherein the modified list of deliverables is generated by the exchange device based on credit rating or a recent credit event of the possible deliverables or their issuers.
